(19) United States
(12) Patent Application Publication
(10) Pub. No.: US 2013/0037609 A1
(43) Pub. Date: Feb. 14, 2013

(54) Method, apparatus and system of unique, coded, visual identifiers that provide a point of contact between people for communication and exchange of information bridging non-virtual and virtual environments

(71) Applicants: CarolAnn Merritt-Munson, (US); Christopher Merritt Munson, (US)

(72) Inventors: CarolAnn Merritt-Munson, (US); Christopher Merritt Munson, (US)

(21) Appl. No.: 13/209,378

(22) Filed: Aug. 13, 2011

(51) Int. Cl. G06F 17/00; G06F 15/16

(52) U.S. Cl. 235/380; 709/206

(57) ABSTRACT

The present invention comprises a method for anonymously relaying personal relationship status of single men or single women desirous of a relationship, as a signal or invitation for contact by potential suitors for matchmaking while facilitating a private, secure point of contact or communications between Client-Users and Prospect-Users. A unique coding system of Visual Identifiers of the present invention, recognizable however undecipherable outside of a private, paid membership, secure computer network facilitates a plurality of Client-User defined levels of communication or exchange of information ranging from denial of contact to electronic messaging, audio chat, video chat or face to face conversation with a potential suitor or Prospect-User in a non-virtual or virtual environment is provided. Further, the presence or display of the apparatus of the Client-User's unique, coded, anonymous, identifier itself in a non-virtual environment performs as a signal or invitation to Prospect-Users that a Client-User is receptive to potential electronic communication at various, individually or mutually defined levels within the domain of said private computer network. Further, the invention provides people a way to take an active role in matchmaking between a friend, family member, or associates by recognition of a Client-User's unique Visual Identifier code and then apprising a Prospect-User of that avenue of communication as a means for parties to contact with one another.

### FIELD OF THE INVENTION

This invention relates generally to a private, secure, computerized arrangement for the administration of data and management of interaction between individuals or entities connected by one or more common relations or interests, desirous of identifying potential suitors for matchmaking relationships. More particularly, the present invention relates to a method of transforming private, personal meta-data into a coded, anonymous Visual Identifier of which the resulting system and apparatus facilitates contact between Client-Users and Prospect-Users within a dedicated, private, secure, non-public, computer network and also in non-virtual environments.

### BACKGROUND OF THE INVENTION

A long-standing challenge in day-to-day life of single men and women is dating and trying to find that perfect match or life partner. Electronic “matchmaking” services and “online dating” have become ubiquitous in modern culture however, the current state of the art is deficient at many levels. These services are limiting as they only offer a small range of prospective partners that have access to a computer, have embraced “online dating” and have subscribed to a particular “match making” or dating service, to which by chance, a potentially suitable partner has also subscribed. In addition, if a “date” is made, many times these electronically arranged meetings result in disappointment because the person one imagined in one's mind, with the information received from a single or a few photographs, ends up not being what was expected. Potential partners may shade the truth, misrepresent or out right lie about their current age, physical stature or appearance. Have you ever seen someone on the street, in the grocery store, train station, shop or restaurant and think “wow . . . I wonder if they're single”? Do you wish you “had their number”, but never see them again ? Conversely, do you wish there was a method you could use to relay your single status to friends of friends, associates and even casual acquaintances that lets people know you're available and gives them an avenue for contact without compromising your direct phone number, personal email or home address ? Currently there is no conduit that bridges the gap between virtual and non-virtual worlds to let people know that you are single, looking for a relationship and welcome contact that could lead to a relationship. There exists, therefore, a need in the art for a secure method, system and apparatus that provides single people a method to publicly relay their personal status, desire for a relationship, desire for contact and to facilitate an avenue for contact that establishes a measure of user defined security to bridge the gap between non-virtual and virtual environments.

### BRIEF SUMMARY OF THE INVENTION

In view of the above described problems existing in the art, the present invention provides a method, apparatus and system for creation, assignment and display of an anonymous, unique, coded, Visual Identifier that relays personal relationship status to other people and facilitates a private, secure point for contact, communication and potential exchange of information via a plurality of user defined levels of communication by means of a dedicated, private, secure, non-public, computer network or in a non-virtual environment. Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention.

FIG. 1 Illustrates embodiments of a dedicated, private, secure, non-public, computer network accessible only by paid subscription in which the method of the coded, Visual Identifier is used to provide visual recognition, identification of personal relationship status, invitation to contact and a point of anonymous, secure communication bridging a non-virtual and virtual environment.

FIG. 2 Illustrates a system in which embodiments for creation, designation and assignment of the unique, coded Visual Identifier that provides visual recognition, identification of personal relationship status and a point of anonymous, secure communication through a dedicated, private, secure, non-public, computer network accessible only by paid subscription or a non-virtual environment can be implemented.

FIG. 3 Illustrates the apparatus of the unique, coded, Visual Identifier comprised of alphanumeric symbols, letters, numbers, symbols, a matrix bar code or any combination thereof; recognizable in a virtual and non-virtual environment by single men or single women desirous of a relationship, as a signal or invitation for contact by potential suitors for matchmaking, yet undecipherable outside of said dedicated, private computer network virtual environment

FIG. 4 Illustrates the apparatus of the unique, coded Visual Identifier using a matrix bar code derived from the alphanumeric symbols, letters, numbers, symbols or any combination thereof as transformed from the Client-User meta-data; recognizable in a virtual and non-virtual environment by single men or single women desirous of a relationship, as a signal or invitation for contact by potential suitors for matchmaking, yet undecipherable outside of said dedicated, private computer network virtual environment.

FIG. 5 Illustrates an example of the embodiment of the apparatus of the unique, coded Visual Identifier displayed on a variety of articles. Regardless of the method of display, while the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

Numbers assigned to elements contained in Figures referred to in the embodiments described in this specification will remain consistent throughout. The invention provides for the method, apparatus and system for creation, assignment and display of an anonymous, unique, coded Visual Identifier that relays personal status to other people and facilitates a point of contact, communication and an exchange of information via a plurality of user defined levels of electronic communication in a virtual environment by means of a dedicated, private, secure, non-public, subscription based computer network or in a non-virtual environment.

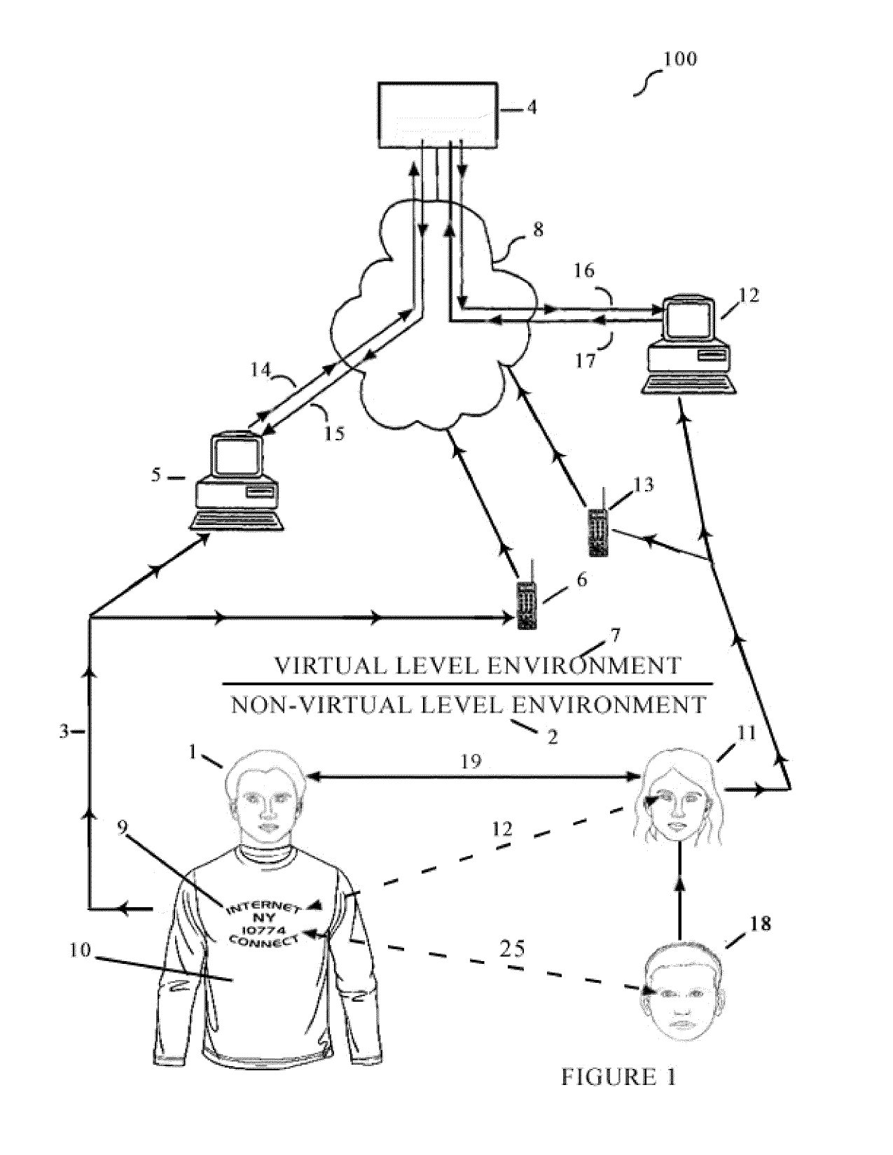

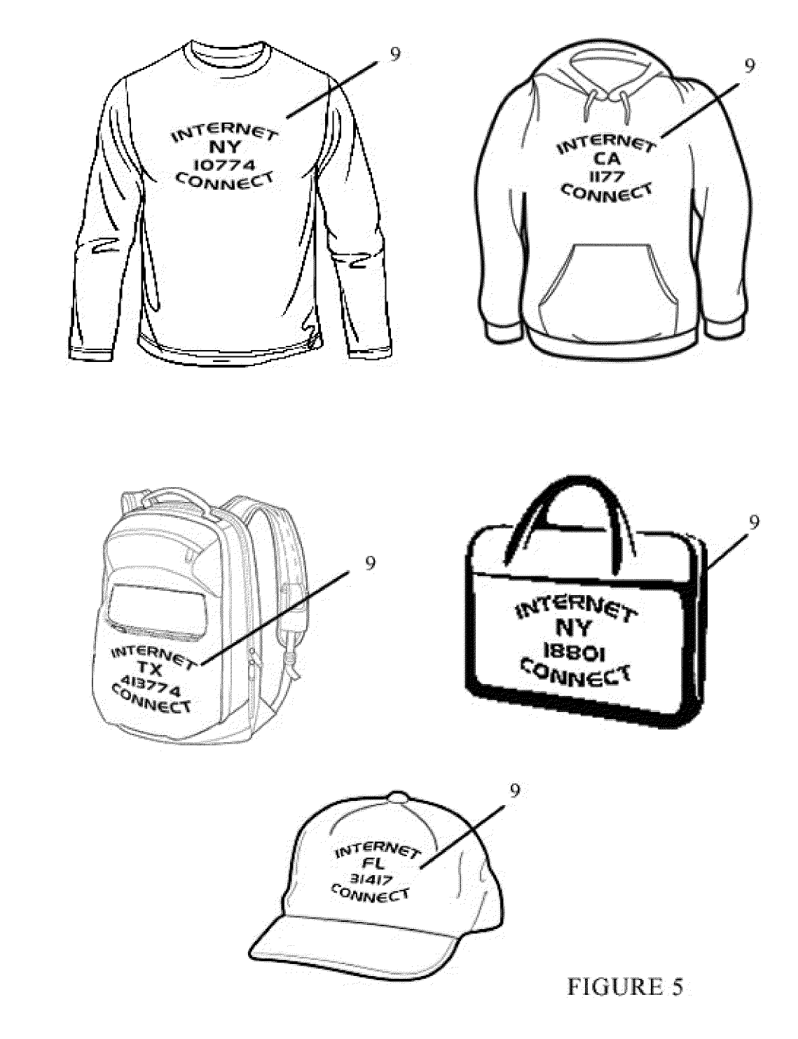

FIG. 1. Illustrates an example system 100 in which the embodiments of the method, apparatus and system of the invention can be implemented. The Client-User 1 in a non-virtual, real world environment 2 initiates meta-data input 3 within the secure, private, non-public, paid membership Computer Network 4 by electronic means such as Client-User computer 5 or Client-User mobile smart phone application 6 into a virtual environment 7 through an internet 8. The Client-User input meta-data profile resides within the Computer Network 4. Computer Network 4 transforms the meta-data to generate, assign and designate a coded, Visual Identifier 9 unique to a specific Client-User 1 and the Visual Identifier 9 is electronically linked to the Client-User meta-data profile residing on Computer Network 4. Via an internet 8. Client-User 1 displays the apparatus of Visual Identifier 9 in either virtual environment 7 or in non-virtual environment 2 by a plurality of items such a shirt 10 or as further illustrated by FIG. 5 shown later in this specification. Client-User 1 displays the assigned Visual Identifier 9 within the non-virtual environment 2. Prospect-User 11 sees and recognizes 12 Visual Identifier 9. Prospect-User 11 employs the apparatus of the coded Visual Identifier 9 to contact or request communication 16 with Client-User 1 via the Computer Network 4 by electronic means such as Prospect-User computer 12 or Prospect-User mobile smart phone application 13 to Client-Users computer 5 in virtual environment 7 through an internet 8. Client-User 1 may now choose to communicate to Prospect-User 11 through a plurality of Client-User defined levels of response consisting of denial of response, one-way electronic mail 14, two-way electronic mail 15 and 17, voice chat, video chat or a combination thereof via an internet 8 through Computer Network 4, provided that Prospect-User 11 subscribes to the paid membership required to access communication through Computer Network 4 and also further access levels of Client-User meta-data administered at the discretion of Client-User 1. A Prospect-User 11 may also make use of Visual Identifier 9 for immediate, direct 19, personal, non-virtual communication between the Prospect-User and the Client-User following the Prospect-User's recognition 12 of the presence of the assigned coded visual identifier 9 as displayed 10 by Client-User 1 in a non-virtual environment 2. Third parties, such as friends of friends, family and business associates 18 may also utilize the method, apparatus and system of the invention by sight and recognition 25 use of the visual identifier 9 in a non-virtual environment 2 to apprise Prospect-User 11 in order to facilitate their contact via Computer Network 4.

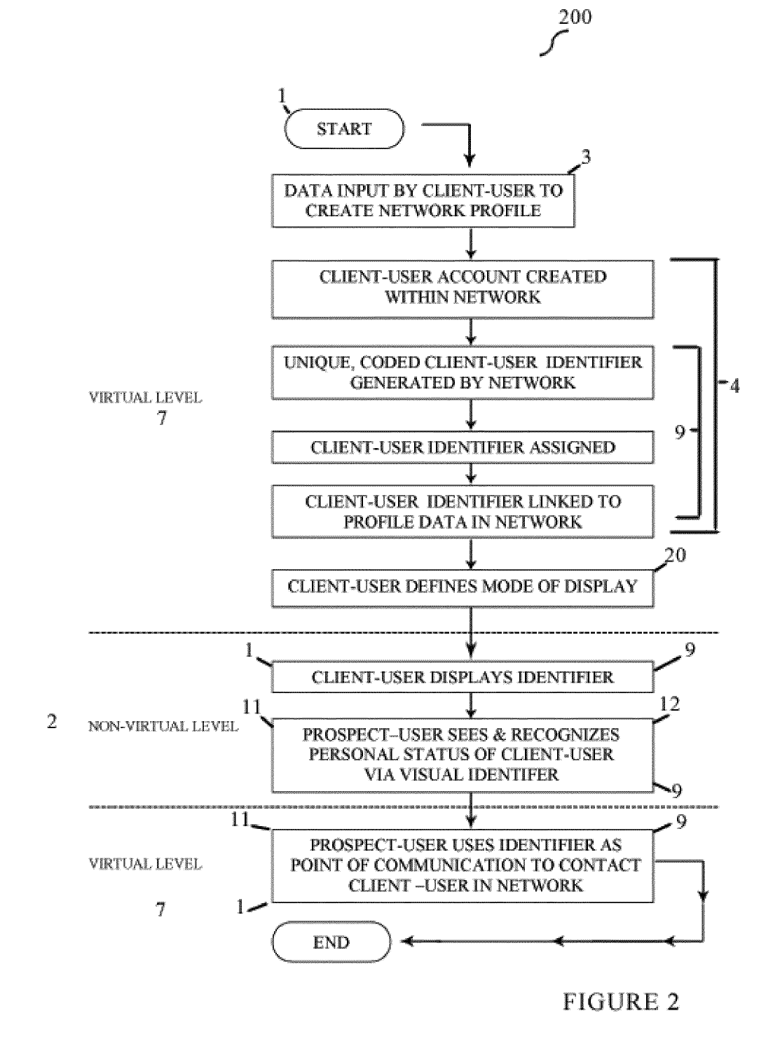

FIG. 2 Illustrates the system 200 in which embodiments for creation, designation and assignment of the unique, coded Visual Identifier that provides visual recognition, identification of personal relationship status and a secure point of communication contact through a dedicated, private, secure, non-public, computer network accessible only by paid subscription in a virtual and non-virtual environment can be implemented. Following paid membership subscription to the Computer Network 4, Client-User 1 initiates meta-data input 3 within the Computer Network 4. Meta-Data is transformed and Coded Visual Identifier 9 is generated by the network, assigned to the specific Client-User 1 and linked to the meta-data profile within Computer Network 4. Client-User 1 defines the mode of display 20 of the apparatus of coded Visual Identifier 9 in either virtual environment 7 or in non-virtual environment 2 by a plurality of items as illustrated by FIG. 5 shown later in this specification. Client-User 1 displays coded Visual Identifier 9. Prospect-User 11 sees and recognizes 12 coded Visual Identifier 9 in non-virtual environment 2. Prospect-User 11 employs the apparatus of coded Visual Identifier 9 to request communication contact with Client-User 1 through virtual environment 7 and via Computer. Network 4. In one embodiment, the apparatus and method of the anonymous. unique, coded Visual Identifier is comprised of alphanumeric symbols, letters, numbers, symbols, a matrix bar code or any combination thereof; recognizable in a virtual and non-virtual environment by single men or single women desirous of a relationship, as a signal or invitation for contact by potential suitors for relationship matchmaking, yet undecipherable outside of said dedicated, private Computer Network 4 virtual environment.

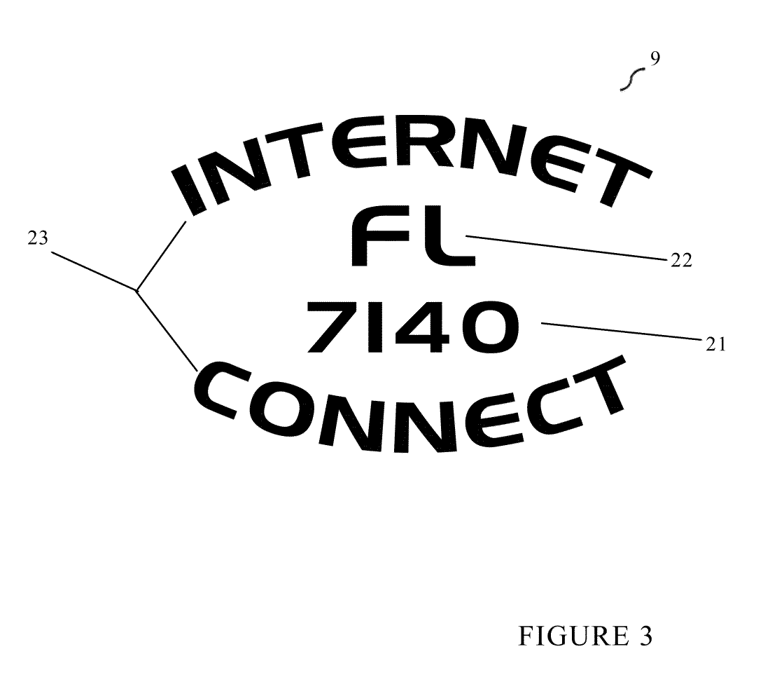

FIG. 3 Illustrates one embodiment of the method and apparatus of the unique coded Visual Identifier 9 comprised of alphanumeric symbols, letters, numbers, symbols, a matrix bar code or any combination thereof; recognizable in a virtual and non-virtual environment by single men or single women desirous of a relationship and displayed as a signal or invitation for contact by potential suitors for relationship matchmaking, yet undecipherable outside of said dedicated, private Computer Network 4 virtual environment

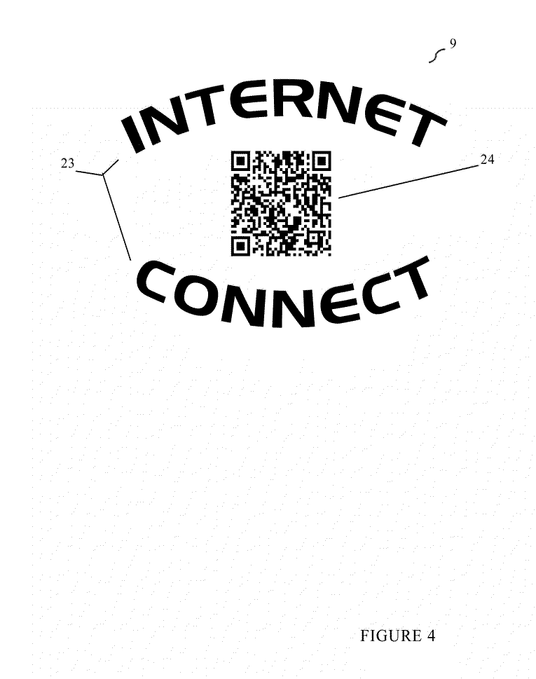

FIG. 4. Illustrates the embodiment of the method of the apparatus of the unique coded identifier 9 using a matrix bar code 24 derived from the alphanumeric symbols, letters, numbers, symbols or any combination thereof as transformed from the Client-User meta-data; recognizable in a virtual and non-virtual environment by single men or single women desirous of a relationship, as a signal or invitation for contact by potential suitors for relationship matchmaking, yet undecipherable outside of said dedicated, private computer network virtual environment. The apparatus of the coded visual identifier, uniquely assigned to the Client-User also provides a point of contact and communication facilitating immediate, direct, personal, non-virtual communication between the Prospect-User and the Client-User following the Prospect-Users recognition of the presence of the assigned, coded Visual Identifier as displayed by the Client-User in a non-virtual environment.

FIG. 5. Illustrates an example of the embodiment of the apparatus of the unique coded Visual Identifier 9 as displayed on a variety of articles. Although the above description is largely directed toward matching people in couples, the methods can be easily adapted to include relationships with more than two people. Additionally, the methods can be adapted to match people for purposes other than romantic relationships. For instance, people who would be suitable for a business relationship can also be identified. The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention. Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed:

1. A method of transforming private, Client-User defined, personal meta-data within a dedicated, private, secure, non-public, computer network into an anonymous, unique, coded, Visual Identifier comprised of alphanumeric symbols, letters, numbers, symbols, a matrix bar code or any combination thereof; recognizable in a virtual and non-virtual environment by single men or single women desirous of a relationship, as a signal or invitation for contact by potential suitors for matchmaking, yet undecipherable outside of said dedicated, private computer network virtual environment; uniquely designated and assigned to a specific paid, Client-User member by said dedicated computer network; of which the underlying, personal meta-data is managed and warehoused within said secure, private computer network and is accessible to a potential suitor or Prospect-User only as a result of a paid membership and at the discretion of the Client-User using varying levels of administrative security control; creating a specific, sole point of contact facilitating varying Client-User defined levels of administrative security control over communication or exchange of information ranging from denial of contact to electronic messaging, audio chat, video chat or face to face conversation with a potential suitor or Prospect-User in a non-virtual or virtual environment.

2. A method of identifying, signaling and inviting contact or the potential of communication with single men or single women desirous of a matchmaking relationship, comprising the steps of: transforming private, Client-User defined, personal, meta-data within a dedicated, private, secure, non-public, paid membership computer network into an anonymous, unique, coded, Visual Identifier comprised of alphanumeric symbols, letters, numbers, symbols, a matrix bar code or any combination thereof; assignment and designation of the unique coded, Visual Identifier to a Client-User by said dedicated computer network; the Client-User displaying the Visual Identifier; a potential suitor or Prospect-User seeing and recognizing a Client-User by way of the Visual Identifier displayed by the Client-User or a third party seeing and recognizing the Client-User Visual Identifier and then relaying the Visual Identifier to a Prospect-User; one-way request for communication directed specifically to the Client-User initiated by the Prospect-User via the Visual Identifier through said secure computer network; Client-User receipt of Prospect-User's request for communication; Client-User's determination to respond to Prospect-User through said secure network, employing a plurality of Client-User administrated levels of security consisting of denial of contact, one-way electronic messaging, two-way electronic messaging, voice chat, video chat or a combination thereof requiring paid membership subscription by Prospect-User to said private computer network in order to receive communication from Client-User; immediate, direct, personal communication in a non-virtual environment between the Prospect-User and the Client-User following the Prospect-User seeing and recognizing the assigned Visual Identifier as displayed by the Client-User.

3. The system of claim 1, wherein the coded Visual Identifier derived from the underlying Client-User meta-data, independent of the substrate or method of display, is represented by, but not limited to a single number in a series of sequential, non-repeating numbers, real numbers, alphanumeric symbols, letters, symbols, a matrix bar code or any combination thereof; is undecipherable outside of said dedicated, private computer network virtual environment; unlike a business card and unrepresentative of any means of conventional form of communication or contact such as an email address, street address, telephone number, specific geographic location or website address thus keeping private the underlying Client-User meta-data warehoused within said computer network; allowing the Client-User to exercise levels of secure, administrative control over the availability of the potential for contact or communication and to what extent the depth of personal data detail, if any, will be shared with a Prospect-User at the discretion of the Client-User on a case by case basis.

4. The apparatus of claim 1, wherein the coded Visual Identifier derived from the underlying Client-User meta-data, independent of method of display, is represented by, but not limited to a single number in a series of sequential, non-repeating numbers, real numbers, alphanumeric symbols, letters, symbols, a matrix bar code or any combination thereof; is undecipherable outside of said dedicated, private computer network virtual environment; unlike a business card and unrepresentative of any means of conventional form of communication or contact such as an email address, street address, telephone number, specific geographic location or website address thus keeping private the underlying Client-User meta-data warehoused within said computer network; allowing the Client-User to exercise levels of secure, administrative control over the availability of the potential for contact or communication and to what extent the depth of personal data detail, if any, will be shared with a Prospect-User at the discretion of the Client-User on a case by case basis.

5. The method of claim 1, wherein the coded visual identifier is characterized by, but not limited to representation of a geographic location denoting a city, state, region, country or any combination thereof, by alphanumeric symbols, letters, numbers, symbols, a matrix bar code or any combination thereof.

6. The apparatus of claim 1, wherein the coded visual identifier is characterized by, but not limited to representation of a geographic location denoting a city, state, region, country or any combination thereof, by alphanumeric symbols, letters, numbers, symbols, a matrix bar code or any combination thereof.

7. The method of claim 1, wherein the coded visual identifier is characterized by, but not limited to representation of the name of the internet based social network, online dating platform or third party electronic bulletin board that designates and assigns the coded visual identifier itself, by alphanumeric symbols, letters, numbers, symbols, a matrix bar code or any combination thereof.

8. The apparatus of claim 1, wherein the coded visual identifier is characterized by, but not limited to representation of the name of the internet based social network, online dating platform or third party electronic bulletin board that designates and assigns the coded visual identifier itself, by alphanumeric symbols, letters, numbers, symbols, a matrix bar code or any combination thereof.

9. The method of claim 1, wherein the coded visual identifier is characterized by, but not limited to a matrix bar code that represents; a single number in a series of sequential, non-repeating, real numbers; a geographic location denoting a city, state, region, country or any combination thereof; the name of the internet based social network, online dating platform or third party electronic bulletin board that designates and assigns the coded visual identifier itself; an internet website address that directs the viewer to a point of contact or communication with the client-user.

10. The apparatus of claim 1, wherein the coded visual identifier is characterized by, but not limited to a matrix bar code that represents; a single number in a series of sequential, non-repeating, real numbers; a geographic location denoting a city, state, region, country or any combination thereof; the name of the internet based social network, online dating platform or third party electronic bulletin board that designates and assigns the coded visual identifier itself; an internet website address that directs the viewer to a point of contact or communication with the client-user.

11. The method of claim 1, wherein the coded visual identifier is displayed on a plurality of articles including, but not limited to; apparel such as shirts, hats, bags, totes, backpacks, jackets, pants, short pants, visors and swimwear; public signage such as billboards and posters; business cards and letterhead; electronic media such as internet websites, social networks, smart phone and mobile phone applications.

12. The method of claim 2, wherein the presence or display of the coded Visual Identifier, viewed in a virtual or non-virtual environment, independent of the substrate or method of display, performs as an anonymous signal, indicator or invitation that a Client-User is receptive to contact and communication from a potential suitor or Prospect-User through a plurality of levels both virtual and non-virtual; with the Visual Identifier derived from the underlying Client-User meta-data is represented by, but not limited to a single number in a series of sequential, non-repeating numbers, real numbers, alphanumeric symbols, letters, symbols, a matrix bar code or any combination thereof; with the Visual Identifier undecipherable outside of said dedicated, private computer network virtual environment; unlike a business card and unrepresentative of any means of conventional form of communication or contact such as an email address, street address, telephone number, specific geographic location or website address thus keeping private the underlying Client-User meta-data warehoused within said computer network; allowing the Client-User to exercise levels of secure, administrative control over the availability of the potential for contact or communication and to what extent the depth of personal data detail, if any, will be shared with a Prospect-User at the discretion of the Client-User on a case by case basis.

13. The system of claim 1, wherein the apparatus of the coded visual identifier designated and assigned by the internet based social network, online dating platform or third party electronic bulletin board provides a link or point of contact and communication to the Client-User by means of the assigning network or in a non-virtual environment.

14. The system of claim 2, wherein the apparatus of the coded visual identifier designated and assigned by the internet based social network, online dating platform or third party electronic bulletin board provides a link or point of contact and communication to the Client-User by means of the assigning network or in a non-virtual environment.

15. The method of claim 1, wherein the presence or display of the coded Visual Identifier, viewed in a virtual or non-virtual environment, independent of the substrate or method of display, performs as an anonymous signal, indicator or invitation that a Client-User is receptive to contact and communication from a potential suitor or Prospect-User through a plurality of levels both virtual and non-virtual; with the Visual Identifier derived from the underlying Client-User meta-data is represented by, but not limited to a single number in a series of sequential, non-repeating numbers, real numbers, alphanumeric symbols, letters, symbols, a matrix bar code or any combination thereof; with the Visual Identifier undecipherable outside of said dedicated, private computer network virtual environment; unlike a business card and unrepresentative of any means of conventional form of communication or contact such as an email address, street address, telephone number, specific geographic location or website address thus keeping private the underlying Client-User meta-data warehoused within said computer network; allowing the Client-User to exercise levels of secure, administrative control over the availability of the potential for contact or communication and to what extent the depth of personal data detail, if any, will be shared with a Prospect-User at the discretion of the Client-User on a case by case basis.
